(19) United States
(12) Patent Application Publication
(10) Pub. No.: US 2014/0063362 A1
(43) Pub. Date: Mar. 6, 2014

(54) Touch-Control Screen and Mobile Communications Device

(71) Applicant: Huawei Device Co., LTD, Shenzhen (CN)

(72) Inventors: Wei Di, Shanghai (CN); Jie Zou, Shenzhen (CN)

(21) Appl. No.: 13/960,152

(22) Filed: Aug. 6, 2013

(30) Foreign Application Priority Data
Aug. 31, 2012 (CN) 201220442450.2

(51) Int. Cl. G02F 1/1333

(52) U.S. Cl. CPC G02F 1/13338
USPC 349/12

(57) ABSTRACT

An embodiment touch-control screen includes a metal frame, a liquid crystal display embedded into the metal frame, and a touch-control panel covering the liquid crystal display, where the touch-control panel includes a transparent conductive shield layer, and the transparent conductive shield layer is electrically connected to the metal frame. An embodiment mobile communications device includes the touch-control screen.

### CROSS-REFERENCE TO RELATED APPLICATIONS

This application claims priority to Chinese Patent Application No. 201220442450.2, filed on Aug. 31, 2012, which is hereby incorporated by reference in its entirety.

### TECHNICAL FIELD

The present utility model relates to the field of touch-control display, in particular, to a touch-control screen and a mobile communications device.

### BACKGROUND

A touch-control screen is the simplest, and most convenient and natural man-machine interactive manner at present. Endowing multimedia with a brand new look, the touch-control screen is applied to various types of electronic devices.

In a touch-control screen, a touch-control panel is arranged on a liquid crystal display, resulting in electromagnetic interference during the work period of the liquid crystal display. Further, the electromagnetic interference affects the performance of the touch-control pane and an electronic device installed with a touch-control screen. For example, for a mobile phone provided with a touch-control screen, the electromagnetic interference generated by the liquid crystal display may directly affect the performance of the touch-control screen and the mobile phone. Meanwhile, the electromagnetic interference generated by the liquid crystal display radiates out from the mobile phone through the touch-control panel. This may intensify the effect on the performance of a mobile phone antenna.

At present, a common method used for shielding the electromagnetic interference generated by the liquid crystal display is to add a conductive and light-penetrable shield layer between the touch-control panel and the liquid crystal display. Despite the effect on shielding the electromagnetic interference to a certain extent, this method has rather high costs.

### SUMMARY

The technical problem that the present utility model needs to solve is to provide a touch-control screen and a mobile communications device, so as to effectively shield the electromagnetic interference generated by the liquid crystal display, simplify processing techniques, and lower the costs.

To solve the foregoing technical problem, the embodiments of the present utility model adopt the following technical solutions:

A touch-control screen includes a metal frame, a liquid crystal display embedded into the metal frame, and a touch-control panel covering the liquid crystal display, where the touch-control panel includes a transparent conductive shield layer, and the transparent conductive shield layer is electrically connected to the metal frame.

The touch-control screen further includes a silicon dioxide shield layer arranged in the touch-control panel at an end near the liquid crystal display, where the transparent conductive shield layer is arranged on the silicon dioxide shield layer at an end far away from the liquid crystal display, the silicon dioxide shield layer has through-holes, and the transparent conductive shield layer is electrically connected to the metal frame through the through-holes.

The silicon dioxide shield layer has a plurality of through-holes, and among the plurality of through-holes, a distance between two adjacent through-holes is a product of a wavelength of interference electromagnetic waves of the liquid crystal display and 1/20.

The through-holes are located near an edge of the silicon dioxide shield layer.

The distance between the through-holes and the edge of the silicon dioxide shield layer is greater than or equal to a creepage distance of test voltage when a static test is performed on the touch-control screen.

The transparent conductive shield layer is connected to the metal frame through conductive adhesive or conductive foam.

A mobile communications device includes the touch-control screen.

In the touch-control screen provided by the embodiments of the present utility model, the transparent conductive shield layer in the touch-control panel and the metal frame are electrically connected. Therefore, the touch-control panel and the metal frame form an integrated structure that absorbs electromagnetic interference, which effectively shields the electromagnetic interference generated by the liquid crystal display. Also, compared with electromagnetic interference shielding manners in the prior art, the utility model has the benefits of simple processing techniques for manufacturing the shielding structure and low costs.

### BRIEF DESCRIPTION OF DRAWINGS

To illustrate the technical solutions in the embodiments of the present utility model or in the prior art more clearly, the following briefly introduces the accompanying drawings required for describing the embodiments or the prior art. Apparently, the accompanying drawings in the following description show merely some embodiments of the present utility model, and persons of ordinary skill in the art may still derive other drawings from these accompanying drawings without creative efforts.

FIG. 1 is a structural schematic diagram of a touch-control screen according to an embodiment of the present utility model;

FIG. 2 is a structural schematic diagram of a cross-section of a touch-control panel according to an embodiment of the present utility model; and

FIG. 3 is a structural schematic diagram of a bottom plane of a touch-control panel according to an embodiment of the present utility model.

### DESCRIPTION OF EMBODIMENTS

The following clearly and completely describes the technical solutions in the embodiments of the present utility model with reference to the accompanying drawings in the embodiments of the present utility model. Apparently, the described embodiments are merely a part rather than all of the embodiments of the present utility model. All other embodiments obtained by persons of ordinary skill in the art based on the embodiments of the present utility model without creative efforts shall fall within the protection scope of the present utility model.

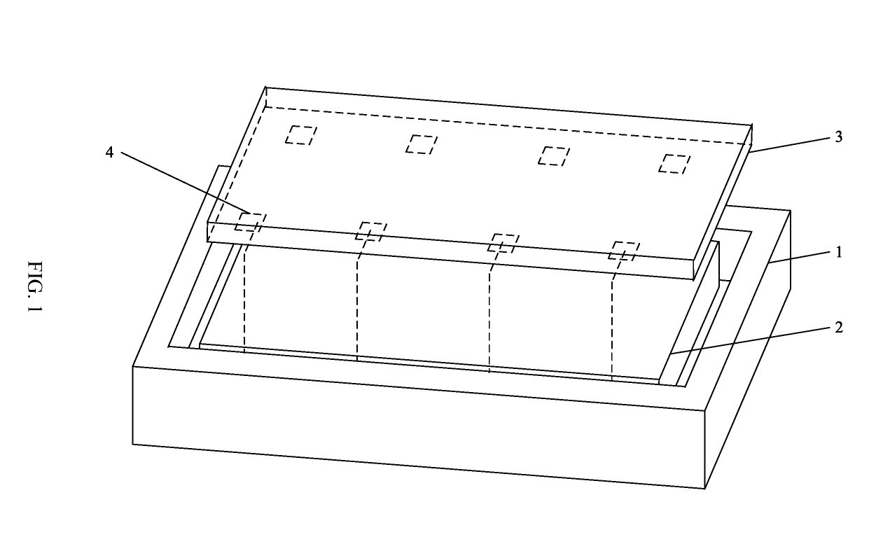

An embodiment of the present utility model provides a touch-control screen. As shown in FIG. 1, the touch-control screen includes: a metal frame 1, a liquid crystal display 2 embedded into the metal frame 1, and a touch-control panel 3 covering the liquid crystal display 2, where the touch-control panel 3 includes a transparent conductive shield layer, and the touch-control screen is characterized in that the transparent conductive shield layer is electrically connected to the metal frame.

The metal frame 1 is arranged on the outer side of the liquid crystal display 2 to support and protect the liquid crystal display 2; and the touch-control panel 3 covers the liquid crystal display 2 and forms an enclosed structure with the metal frame 1, so that the liquid crystal display 2 is sealed in the structure. Therefore, the electromagnetic interference generated by the liquid crystal display 2 is sealed in the enclosed structure formed by the metal frame 1 and the touch-control panel 3, may only radiate into the metal frame 1 or the touch-control panel 3, and may not directly radiate out of the enclosed structure.

Because the metal frame 1 is connected to a ground cable of an electronic device where the touch-control screen is located, and in the embodiment of the present utility model, the transparent conductive shield layer in the touch-control panel 3 is electrically connected to the metal frame 1, so that the transparent conductive shield layer is also connected to the ground cable of the electronic device to form a shielded body. In this case, the electromagnetic interference generated on the top surface of the liquid crystal display 2 is absorbed by the transparent conductive shield layer in the touch-control panel 3 and is led to the ground cable. Therefore, the electromagnetic interference is prevented from penetrating the touch-control panel to interfere the touch-control panel and the electronic device. The electromagnetic interference generated on the lateral surface and the bottom surface of the liquid crystal display 2 is absorbed by the metal frame 1 and led to the ground cable. After the transparent conductive shield layer is electrically connected to the metal frame 1, the touch-control panel 3 and the metal frame 1 form an integrated structure that absorbs electromagnetic interference, where the structure encloses the liquid crystal display 2 inside, thereby effectively shielding the electromagnetic interference generated by the liquid crystal display 2.

In the touch-control screen provided by the embodiment of the present utility model, the transparent conductive shield layer in the touch-control panel and the metal frame are electrically connected. Therefore, the touch-control panel and the metal frame form an integrated structure that absorbs electromagnetic interference, which effectively shields the electromagnetic interference generated by the liquid crystal display. Also, compared with electromagnetic interference shielding manners in the prior art, the utility model has the benefits of simple processing techniques for manufacturing the shielding structure and low costs.

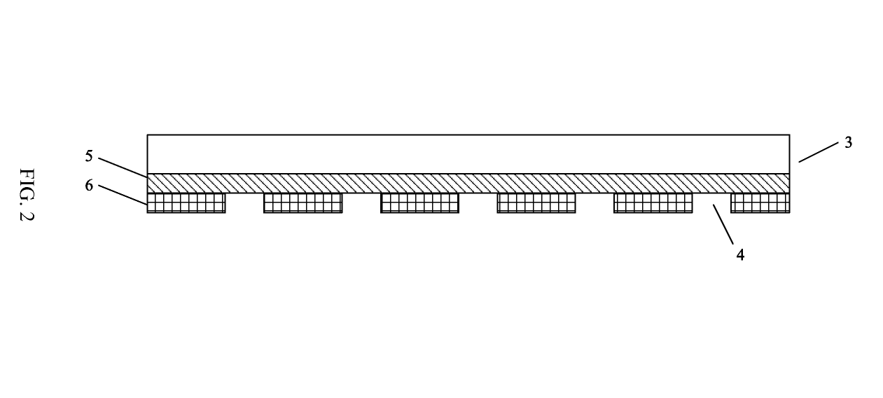

Further, in the embodiment of the present utility model, as shown in FIG. 1 and FIG. 2, the touch-control screen 3 further includes a silicon dioxide shield layer 6 arranged in the touch-control panel 3 at an end near the liquid crystal display 2, the transparent conductive shield layer 5 is arranged on the silicon dioxide shield layer 6 at an end far away from the liquid crystal display 2, the silicon dioxide shield layer 6 has through-holes 4, and the transparent conductive shield layer 5 is electrically connected to the metal frame 1 through the through-holes 4.

The touch-control panel 3 adopts a multi-layered structure which implements the touch-control function of the touch-control panel. In the multi-layered structure of the touch-control panel, the silicon dioxide shield layer 6 is arranged at the bottom, and the transparent conductive shield layer 5 is arranged on the silicon dioxide shield layer 6. In the embodiment of the present utility model, the through-holes 4 are formed on the surface of the silicon dioxide shield layer 6, and the through-holes 4 penetrate the upper and lower surfaces of the silicon dioxide shield layer 6, so that part of the transparent conductive shield layer 5 arranged in the silicon dioxide shield layer 6 exposed out of the silicon dioxide shield layer 6 at the outermost layer of the touch-control panel 3. The exposed points of the transparent conductive shield layer 5 are connected to the metal frame 1 to achieve electric connection between the transparent conductive shield layer 5 and the metal frame 1 through the through-holes 4.

Optionally, the transparent conductive shield layer may be electrically connected to the metal frame through conductive adhesive or conductive foam. The exposed points of the transparent conductive shield layer may be electrically connected to the metal frame in an electroplating manner, and the exposed points of the transparent conductive shield layer may be connected to the metal frame through other transparent conductive materials, where one end of a conductive material is connected to the exposed points of the transparent conductive shield layer and the other end of the conductive material may be connected to the side wall on the inner wall of the metal frame, and the conductive material is arranged in a place other than that of the liquid crystal display, so that the arrangement of the liquid crystal display is not affected.

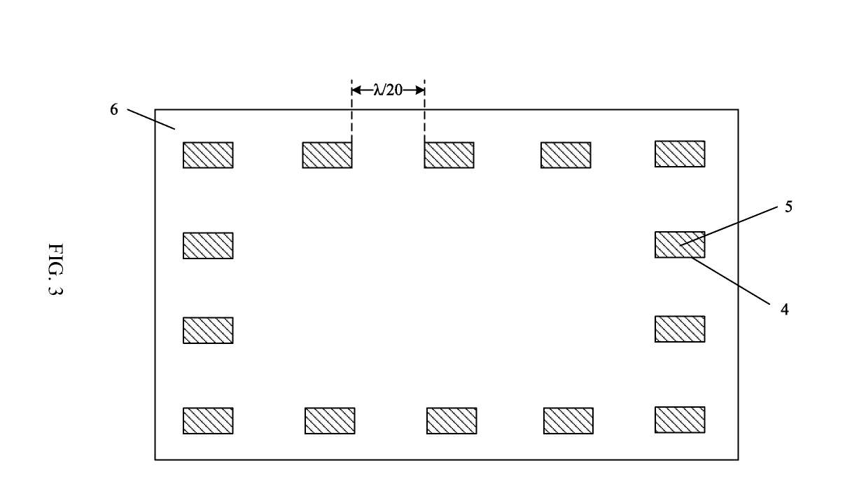

Further, in the embodiment of the present utility model, as shown in FIG. 3, the silicon dioxide shield layer 6 has a plurality of through-holes, so that the transparent conductive shield layer 5 has a plurality of exposed points. Among the plurality of through-holes, the distance between two adjacent through-holes is the product of a wavelength of interference electromagnetic waves of the liquid crystal display and 1/20. If the wavelength of interference electromagnetic waves of the liquid crystal display is λ, set the distance between two adjacent through-holes 4 to λ/20. Setting the distance between two adjacent through-holes 4 to be 1/20 of the interference wavelength may improve the shielding effect of the transparent conductive shield layer and prevent the leakage of interference electromagnetic waves.

Further, in the embodiment of the present utility model, the through-holes are arranged near an edge of the silicon dioxide shield layer. The through-holes are arranged in a position near the four edges of the silicon dioxide shield layer, so that the length of a conductive material used for connecting the exposed points of the transparent conductive shield layer 5 and the metal frame is shortened to lower the costs. Meanwhile, the position of the conductive material may be near the edge of the touch-control panel to reduce the affect caused by the conductive material on the light transmission of the touch-control panel.

Further, in the embodiment of the present utility model, the distance between the positions of the through-holes 4 and the edge of the silicon dioxide shield layer 6 is greater than or equal to the creepage distance of test voltage when a static test is performed on the touch-control screen. When a static test is performed on the touch-control screen provided by the embodiment of the present utility model, static electricity may directly act on the exposed points of the transparent conductive shield layer 5 through the edge of the touch-control panel to damage the touch-control panel, and therefore, in the present utility model, the distance between the through-holes 4 and the edge of the silicon dioxide shield layer 6 is set to be greater than or equal to the creepage distance of test voltage when the static test is performed. In this case, during the static test, the test voltage may not directly act on the exposed points of the transparent conductive shield layer 5 through the edge of the silicon dioxide shield layer 6, preventing the damage caused by static electricity on the touch-control panel.

An embodiment of the present utility model provides a mobile communications device which includes the touch-control screen provided by the foregoing embodiments. After the touch-control screen provided by the present utility model is arranged on the mobile communications device, the electromagnetic interference generated by the liquid crystal display is effectively prevented from interfering with antennas of the mobile communications device.

In the touch-control screen and the mobile communications device provided by the embodiments of the present utility model, the through-holes are arranged on the surface of the silicon dioxide shield layer, so that part of the transparent conductive shield layer is exposed out of the touch-control panel. By connecting the exposed points of the transparent conductive shield layer to the metal frame, the transparent conductive shield layer and the metal frame are electrically connected, and further, the touch-control panel and the metal frame form an integrated structure that absorbs electromagnetic interference, thereby effectively shielding electromagnetic interference generated by the liquid crystal display. Also, compared with electromagnetic interference shielding manners in the prior art, the utility model has the benefits of simple processing techniques for manufacturing the shielding structure and low costs.

The foregoing descriptions are merely specific embodiments of the present utility model, but are not intended to limit the protection scope of the present utility model. Any variation or replacement readily figured out by persons skilled in the art within the technical scope disclosed in the present utility model shall fall within the protection scope of the present utility model. Therefore, the protection scope of the present utility model shall be subject to the protection scope of the claims.

1-15. (canceled)

16. A touch-control screen, comprising:
a metal frame;
a liquid crystal display embedded into the metal frame; and
a touch-control panel covering the liquid crystal display, wherein the touch-control panel comprises a transparent conductive shield layer that is electrically connected to the metal frame.

17. The touch-control screen according to claim 16, wherein the touch-control panel further comprises a silicon dioxide shield layer arranged in the touch-control panel at a first end near the liquid crystal display, wherein the transparent conductive shield layer is arranged on the silicon dioxide shield layer at a second end far away from the liquid crystal display, wherein the silicon dioxide shield layer has a plurality of through-holes, and wherein the transparent conductive shield layer is electrically connected to the metal frame through the through-holes.

18. The touch-control screen according to claim 17, wherein, among the plurality of through-holes, a distance between two adjacent through-holes is a product of a wavelength of interference electromagnetic waves of the liquid crystal display and 1/20.

19. The touch-control screen according to claim 18, wherein the plurality of through-holes are located near an edge of the silicon dioxide shield layer.

20. The touch-control screen according to claim 19, wherein a distance between the plurality of through-holes and the edge of the silicon dioxide shield layer is greater than or equal to a creepage distance of test voltage when a static test is performed on the touch-control screen.

21. The touch-control screen according to claim 16, wherein the transparent conductive shield layer is connected to the metal frame through conductive adhesive or conductive foam.

22. The touch-control screen according to claim 17, wherein the transparent conductive shield layer is connected to the metal frame through conductive adhesive or conductive foam.

23. The touch-control screen according to claim 18, wherein the transparent conductive shield layer is connected to the metal frame through conductive adhesive or conductive foam.

24. The touch-control screen according to claim 19, wherein the transparent conductive shield layer is connected to the metal frame through conductive adhesive or conductive foam.

25. The touch-control screen according to claim 20, wherein the transparent conductive shield layer is connected to the metal frame through conductive adhesive or conductive foam.

26. A mobile communications device, comprising:
a touch-control screen comprising
a metal frame;
a liquid crystal display embedded into the metal frame; and
a touch-control panel covering the liquid crystal display, wherein the touch-control panel comprises a transparent conductive shield layer that is electrically connected to the metal frame.

27. The mobile communications device according to claim 26, wherein the touch-control panel further comprises a silicon dioxide shield layer arranged in the touch-control panel at a first end near the liquid crystal display, wherein the transparent conductive shield layer is arranged on the silicon dioxide shield layer at a second end far away from the liquid crystal display, wherein the silicon dioxide shield layer has a plurality of through-holes, and wherein the transparent conductive shield layer is electrically connected to the metal frame through the through-holes.

28. The mobile communications device according to claim 27, wherein, among the plurality of through-holes, a distance between two adjacent through-holes is a product of a wavelength of interference electromagnetic waves of the liquid crystal display and 1/20.

29. The mobile communications device according to claim 28, wherein the plurality of through-holes are located near an edge of the silicon dioxide shield layer.

30. The mobile communications device according to claim 29, wherein a distance between the plurality of through-holes and the edge of the silicon dioxide shield layer is greater than or equal to a creepage distance of test voltage when a static test is performed on the touch-control screen.

31. The mobile communications device according to claim 26, wherein the transparent conductive shield layer is connected to the metal frame through conductive adhesive or conductive foam.
